(19) United States
(12) Patent Application Publication
(10) Pub. No.: US 2009/0279966 A1
(43) Pub. Date: Nov. 12, 2009

(54) REVERSE FLOW MILL

(75) Inventor: STEVEN G. BLAIR, TOMBALL, TX (US)

Correspondence Address: CANTOR COLBURN, LLP, 20 Church Street, 22nd Floor, Hartford, CT, 06103, US

(73) Assignee: BAKER HUGHES INCORPORATED, HOUSTON, TX (US)

(21) Appl. No.: 12/395,097

(22) Filed: Feb. 27, 2009

Related U.S. Application Data
(60) Provisional application No. 61/052,529, filed on May 12, 2008.

(51) Int. Cl. B23B 35/00; B23B 51/06

(52) U.S. Cl. 408/1 R; 408/59

(57) ABSTRACT

A drilling or milling tool including a body; a cutting tip at the body; a fluid supply channel extending through the body; one or more tip outlets fluidly connected to the channel; and one or more venturi outlets fluidly connected to the channel, the tip outlets and the venturi outlets having a fluid flow ratio relative to each other such that fluid pressure at the tip does not exceed hydrostatic pressure in a wellbore in which the tool is employed and a method.

### CROSS REFERENCE TO RELATED APPLICATION

This application is a non-provisional application of U.S. Ser. No. 61/052,529, filed May 15, 2008, the contents of each of which are incorporated by reference herein in their entirety.

### BACKGROUND

In order to remove material cuttings and debris ahead of a milling or drilling tool in a downhole environment, fluid is pumped through the milling or drilling tool to be ejected near a cutting tip of the tool. The fluid carries such cuttings and debris away from the cutting tip and usually through an annulus defined about the drilling of milling tool to a remote location such as the surface of the well. The fluid keeps the cutting tip clean so that drilling or milling progress can continue substantially without impedance due to debris fouling the cutting tip. While this method has been used for decades and does indeed keep the cutting tip acceptably clean, the pumping action can impede cutting performance due to “pump-off”, a well known industry term relating to the pumped fluid itself creating a barrier to effective drilling or milling due to “float” of the drilling or milling tool. Methods and apparatus for improving drilling and milling performance are always well received by the art.

### SUMMARY

A drilling or milling tool includes a body; a cutting tip at the body; a fluid supply channel extending through the body; one or more tip outlets fluidly connected to the channel; and one or more venturi outlets fluidly connected to the channel, the tip outlets and the venturi outlets having a fluid flow ratio relative to each other such that fluid pressure at the tip does not exceed hydrostatic pressure in a wellbore in which the tool is employed.

A method for drilling or milling includes directing a flow of fluid to one or more tip outlets of a drilling or milling tool; directing a flow of fluid to one or more venturi outlets of the drilling or milling tool; and proportioning the flow of fluid to maintain a pressure at a cutting tip of the drilling or milling tool at or below hydrostatic pressure.

### BRIEF DESCRIPTION OF THE DRAWINGS

Referring now to the drawings wherein like elements are numbered alike in the several Figures:

FIG. 1 is a schematic sectional view of a drilling or milling tool as disclosed herein disposed in a borehole.

### DETAILED DESCRIPTION

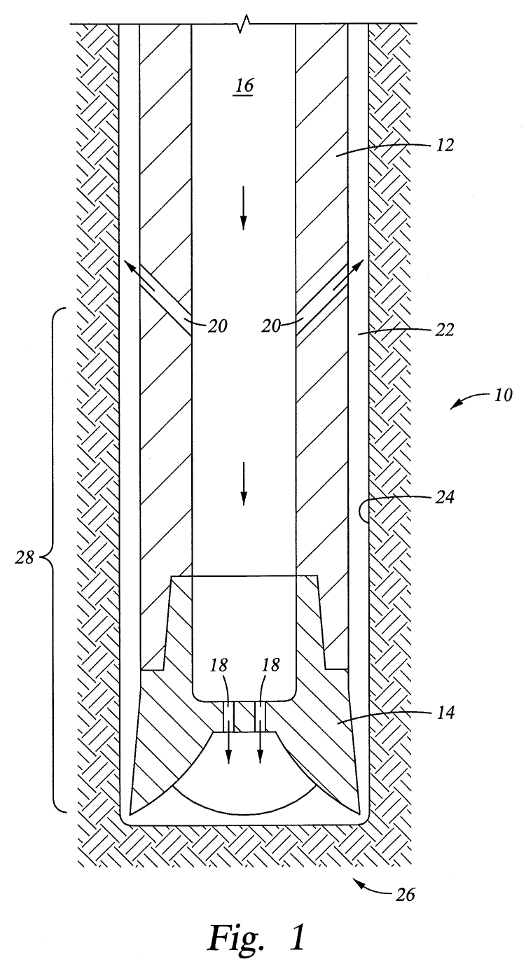

Referring to FIG. 1, a drilling or milling tool 10 is illustrated having a body 12, a cutting tip 14, a fluid supply channel 16 and fluid supply tip outlet(s) 18 and venturi outlet(s) 20. Fluid supply outlet(s) 18 are positioned similarly to those of the prior art to direct fluid to the cutting tip 14 for cooling and debris removal but function considerably differently. As taught herein, the outlet(s) 18 are to have a restricted flow relative to the total flow of fluid through the channel 16. A relatively larger amount of the flow is directed through outlet(s) 20. This accomplishes three things: the first is that pressure buildup at the tip 14 is reduced or eliminated and in any event does not exceed hydrostatic pressure since there is insufficient fluid being pumped to the front of the cutting tip 14 to cause a pressure buildup and therefore pump-off; second, fluid is still supplied to the cutting tip 14 to remove debris therefrom (with assistance from a created venturi effect, discussed below); and third, thrust from the outlet(s) 20 increases weight on bit (WOB) for greater cutting or abrading speed.

In order to achieve the desirable results indicated above, and because in the illustrated embodiment the channel 16 supplies fluid to both outlet(s) 18 and outlet(s) 20, the total outlet area presented by outlet(s) 18 and the total outlet area presented by outlet(s) 20 must be adjusted to ensure that a sufficient amount of fluid is ejected from outlet(s) 18 to facilitate clearing of debris but insufficient to result in pump-off In one embodiment, the outlet(s) 18 represent up to about ¼ to about ⅓ of the total outlet area and the outlet(s) 20 represent the other about ⅔ to about ¾ of total outlet area and fluid is proportioned automatically based upon the size ratio of the outlet(s) 18 and the outlet(s) 20.

While fluid is still supplied to the cutting tip 14 in the configuration herein taught, the lack of a pressure head at that location means that the fluid will not automatically flow to an annulus 22 between the tool 10 and a borehole wall 24 to clear debris away from the cutting area 26. In order to remove this debris, a venturi effect is relied upon to draw the fluid from the cutting tip 14, entraining debris therewith. The venturi effect is produced by the fluid exiting outlet(s) 20 in a direction having some angle away from the tip 14. The angle may be from more than 90 degrees to a longitudinal axis of the tool 10 to about 180 degrees to the axis of the tool 10 such as where a portion of the fluid flow in the channel 16 is turned around to flow substantially uphole. The venturi effect produces a lower pressure in the fluid located in the bracketed area 28 due to the jetted fluid exiting outlet(s) 20 causing fluid to move away from the tip 14. This lower pressure area will tend to pull fluid exiting outlet(s) 18 across the cutting tip 14 and into the annulus 22. This debris will be conveyed by the venturi effect up to the outlet(s) 20 whereat the debris will be caught up in the jetted fluid from outlet(s) 20 and pushed farther uphole. The greater the angle of the fluid redirection noted above, the greater the venturi effect. With a greater venturi effect comes a more efficient cleaning of the cutting area 26 while still avoiding a pressure head in the tip area i.e. below hydrostatic pressure. At or a pressure value in the tip area that does not exceed hydrostatic pressure and in one embodiment where the pressure value is maintained below hydrostatic pressure, the bit will not experience pumpoff.

In addition to the creation of the venturi effect, the fluid jetting out of outlets 20 creates a directional thrust and further acts to increase WOB to the advantage of the operation.

While preferred embodiments have been shown and described, modifications and substitutions may be made thereto without departing from the spirit and scope of the invention. Accordingly, it is to be understood that the present invention has been described by way of illustrations and not limitation.

1. A drilling or milling tool comprising:
a body;
a cutting tip at the body;
a fluid supply channel extending through the body;
one or more tip outlets fluidly connected to the channel; and
one or more venturi outlets fluidly connected to the channel, the tip outlets and the venturi outlets having a fluid flow ratio relative to each other such that fluid pressure at the tip does not exceed hydrostatic pressure in a wellbore in which the tool is employed.

2. The drilling or milling tool as claimed in claim 1 wherein the fluid flow ratio is about ¼ to about ⅓ to the one or more tip outlets and about ⅔ to about ¾ to the one or more venturi outlets.

3. The drilling or milling tool as claimed in claim 1 wherein an angle of the one or more venturi outlets is greater than about 90 degrees to a longitudinal axis of the tool.

4. The drilling or milling tool as claimed in claim 1 wherein debris is cleared from the tip of the tool by fluid moving due to exposure to a low pressure in an annulus around the tool during use.

5. The drilling or milling tool as claimed in claim 1 wherein the venturi outlets are angled relative to a longitudinal axis of the tool.

6. The drilling or milling tool as claimed in claim 5 wherein angle is greater than about 90 degrees counted from the tip of the body of the tool.

7. The drilling or milling tool as claimed in claim 5 wherein angle is up to about 180 degrees counted from the tip of the body of the tool.

8. The drilling or milling tool as claimed in claim 1 wherein the one or more venturi outlets are angled such that a lower pressure area is created at an annular area around the tool in use between the one or more venturi outlets and the tip of the body of the tool.

9. The drilling or milling tool as claimed in claim 1 wherein the fluid pressure at the tip is maintained below hydrostatic pressure.

10. A method for drilling or milling comprising:
directing a flow of fluid to one or more tip outlets of a drilling or milling tool;
directing a flow of fluid to one or more venturi outlets of the drilling or milling tool; and
proportioning the flow of fluid to maintain a pressure at a cutting tip of the drilling or milling tool at or below hydrostatic pressure.

11. The method as claimed in claim 10 wherein the proportioning of fluid occurs automatically based upon relative size of the one or more tip outlets versus the one or more venturi outlets.

12. The method as claimed in claim 10 wherein the method further includes increasing WOB by jetting fluid from the one or more venturi outlets in a direction away from the tip of the body of the tool.

13. The method as claimed in claim 10 wherein the method further includes creating a lower pressure fluid area at an annular area of the tool.

14. The method as claimed in claim 13 wherein the method further includes clearing debris from a drilling or milling operation away from the cutting tip of the tool by drawing with the venturi, fluid exiting the one or more tip outlets toward an annulus of the tool when in use.

15. The method as claimed in claim 10 further comprising maintaining the pressure at the cutting tip of the drilling or milling tool below hydrostatic pressure.
